(19) United States
(12) Patent Application Publication
(10) Pub. No.: US 2016/0323063 A1
(43) Pub. Date: Nov. 3, 2016

(54) Bundled Forward Error Correction (FEC) for Multiple Sequenced Flows

(71) Applicant: QUALCOMM Incorporated, San Diego, CA (US)

(72) Inventors: Giridhar Dhati MANDYAM, San Diego, CA (US); Thomas Stockhammer, Bergen (DE); Michael George Luby, Berkeley, CA (US)

(21) Appl. No.: 15/138,451

(22) Filed: Apr. 26, 2016

Related U.S. Application Data
(60) Provisional application No. 62/155,639, filed on May 1, 2015.

(51) Int. Cl. H04L 1/00; H04L 29/06

(52) U.S. Cl. CPC H04L 1/0041; H04L 65/608

(57) ABSTRACT

Various embodiments enable “bundled FEC protection,” in which a single repair flow may be used to provide recovery protection for a plurality of individual source RTP streams. The embodiment techniques may utilize novel FEC source payload and repair payload definitions that enable a single repair flow to be defined for multiple RTP flows. For example, as FEC FRAME Raptor code options do not currently address the case of bundled protection of multiple media types over multiple real-time transport protocol (RTP) synchronization sources (SSRC's), RTP stream header extensions may be utilized to allow a single FEC RTP stream to be configured to provide redundancy for a plurality of source RTP streams, regardless of their content type (e.g., audio or video). Based on such extensions, the embodiment techniques allow for protection of multiple source RTP streams that each has a unique sequence number space.

### RELATED APPLICATIONS

This application claims the benefit of priority to U.S. Provisional Application No. 62/155,639 entitled “Bundled Forward Flow Error Correction (FEC) for Multiple Sequenced Flows” filed May 1, 2015, the entire contents of which are hereby incorporated by reference.

### BACKGROUND

Forward error correction (FEC) is a mechanism for providing reliability to data being sent over a communications link. With conventional FEC techniques, there may be less reliance on retransmission protocols to ensure reliability of data communications, as the data communications themselves may include redundant, encoded information suitable for recovering missing or otherwise inaccessible portions (or packets) of the communications. FEC frameworks for arbitrary streaming protocols exist, such as defined by the Internet Engineering Task Force's FEC Framework (referred to as “FEC FRAME”). In particular, FEC FRAME is capable of providing some FEC functionalities for use with sequenced protocols, such as Real-Time Protocol (RTP) that utilizes a sequence number (i.e., packet identifier (“ID”)) for each packet of an RTP stream. Such FEC for streaming may utilize various standardized FEC codes, such as Reed-Solomon, Raptor, RaptorQ, and low-density parity-check code (LDPC).

### SUMMARY

Various embodiments include methods and computing devices for extending Forward Error Correction (FEC) to protect a plurality of Real-Time Protocol (RTP) streams using a single FEC RTP stream. Various embodiments may include exchanging, via a processor of a sending computing device, session initialization data with a receiving computing device, generating, via the processor, source RTP stream data for the plurality of source RTP streams, generating, via the processor, FEC RTP stream data for an FEC RTP stream corresponding to the plurality of source RTP streams, and transmitting the plurality of source RTP streams and the FEC RTP stream to the receiving computing device. Some embodiments may further include adjusting, via the processor, a header extension of each of the plurality of source RTP streams to include a source FEC payload identifier (ID). Some embodiments may further include adjusting, via the processor, the FEC RTP stream to include a repair FEC payload identifier (ID).

Some embodiments may further include constructing, via the processor, a repair block of the FEC RTP stream for the plurality of source RTP streams, wherein the repair block includes at least a flow identifier, a length indicator, and s values for each of the source RTP streams, and registering, via the processor, a payload format of the FEC RTP stream as a bundled media type.

In some embodiments, each of the plurality of source RTP streams is one of an audio stream and a video stream. In some embodiments, the session initialization data comprises Session Description Protocol (SDP) data.

Various embodiments may include receiving, via a processor of a receiving computing device, a plurality of source RTP streams and a FEC RTP stream from a sending computing device, determining, via the processor, whether any source block data is missing from any of the plurality of source RTP streams, retrieving, via the processor, missing source block data from repair blocks of the FEC RTP stream in response to determining that there is missing source block data, and using, via the processor, the data of the plurality of source RTP streams. In some embodiments, each of the plurality of source RTP streams is one of an audio stream and a video stream.

Further embodiments include a sending computing device including a transceiver and a processor configured with processor-executable instruction to perform operations of the methods for generating and transmitting a plurality of source RTP streams and the FEC RTP stream to a receiving computing device summarized above.

Further embodiments include a receiving computing device including a transceiver and a processor configured with processor-executable instruction to perform operations of the methods of receiving and processing a plurality of source RTP streams and the FEC RTP stream from a transmitting computing device summarized above.

### BRIEF DESCRIPTION OF THE DRAWINGS

The accompanying drawings, which are incorporated herein and constitute part of this specification, illustrate various embodiments of the claims, and together with the general description given above and the detailed description given below, serve to explain the features of the claims.

FIGS. 1A-1B are diagrams illustrating conventional RTP stream exchanges between computing devices.

FIG. 2 is a diagram illustrating a bundled FEC RTP stream transmitted alongside a plurality of source RTP streams according to some embodiments.

FIG. 3A is a process flow diagram illustrating embodiment methods for computing devices to exchange source RTP streams with header extensions along with bundled FEC RTP streams.

FIG. 3B is a diagram of SDP data indicating a bundled FEC RTP stream corresponding to source RTP streams with header extensions suitable for use in some embodiments.

FIG. 4A is a process flow diagram illustrating embodiment methods for computing devices to exchange RTP streams with bundled FEC RTP streams.

FIG. 4B is a diagram of an FEC payload suitable for use in some embodiments.

FIG. 4C is a diagram of SDP data indicating a bundled FEC RTP stream corresponding to source RTP streams suitable for use in some embodiments.

FIG. 5A is a process flow diagram illustrating an embodiment method for a sending computing device to transmit RTP streams with bundled FEC RTP streams in various configurations.

FIG. 5B is a process flow diagram illustrating an embodiment method for a receiving computing device to receive RTP streams with bundled FEC RTP streams in various configurations.

FIG. 6 is a component block diagram of a mobile computing device suitable for use in some embodiments.

FIG. 7 is a component block diagram of a server computing device suitable for use in some embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

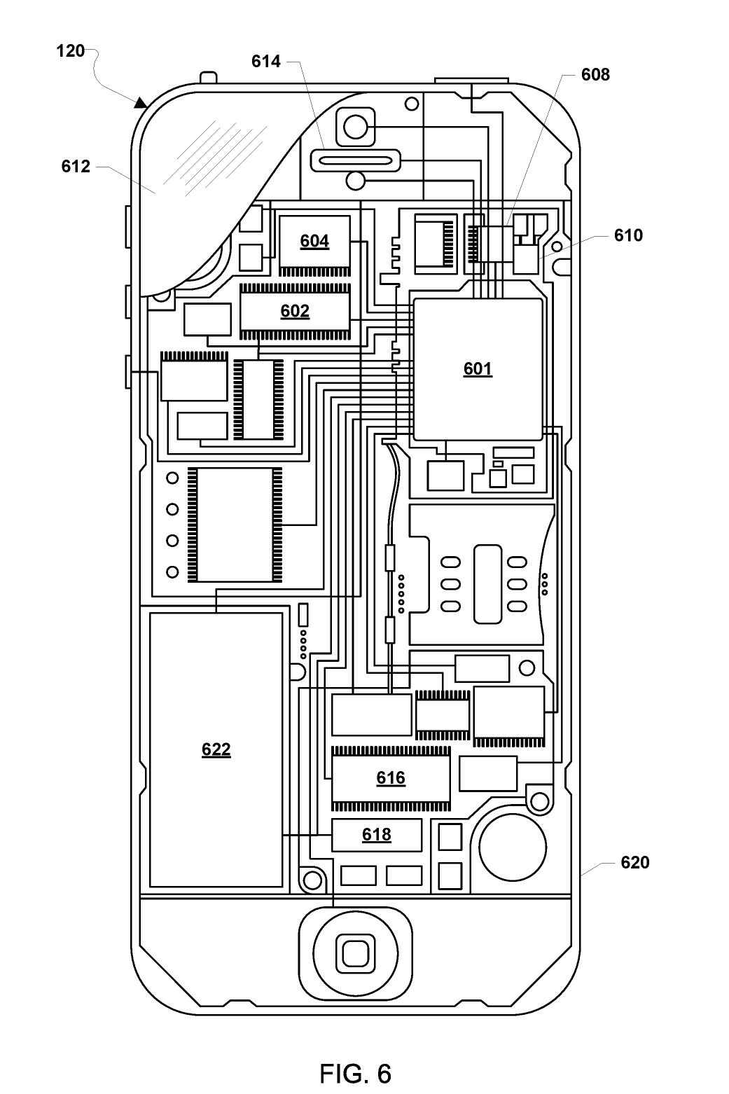

The term “computing device” is used herein to refer to an electronic device equipped with at least a processor. Examples of computing devices may include mobile devices (e.g., cellular telephones, wearable devices, smart-phones, web-pads, tablet computers, Internet enabled cellular telephones, Wi-Fi® enabled electronic devices, personal data assistants (PDA's), laptop computers, etc.), personal computers, and server computing devices. In various embodiments, computing devices may be configured with memory or storage as well as networking capabilities, such as network transceiver(s) and antenna(s) configured to establish a wide area network (WAN) connection (e.g., a cellular network connection, etc.) and/or a local area network (LAN) connection (e.g., a wired/wireless connection to the Internet via a Wi-Fi® router, etc.). A mobile computing device suitable for use with the various embodiments is described below with reference to FIG. 6.

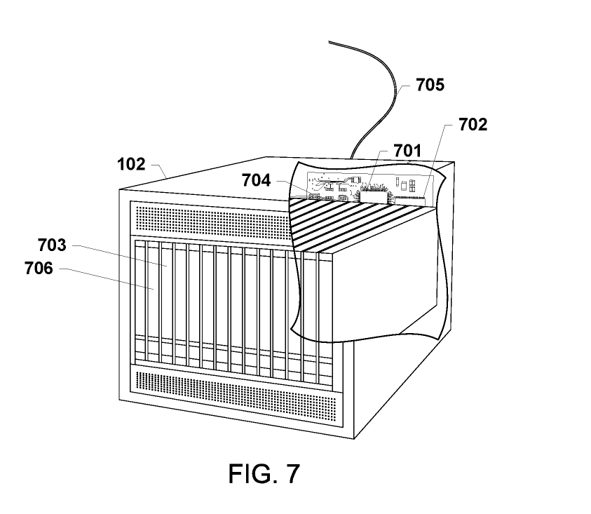

The term “server” is used to refer to any computing device capable of functioning as a server, such as a master exchange server, web server, mail server, document server, and a personal or mobile computing device configured with software to execute server functions (e.g., a “light server”). A server may be a dedicated computing device or a computing device including a server module (e.g., running an application that may cause the computing device to operate as a server). A server module (or server application) may be a full function server module, or a light or secondary server module (e.g., light or secondary server application). A light server or secondary server may be a slimmed-down version of server type functionality that can be implemented on a personal or mobile computing device, such as a smart phone, thereby enabling it to function as an Internet server (e.g., an enterprise e-mail server) to a limited extent, such as necessary to provide the functionality described herein. A server suitable for use with the various embodiments is described below with reference to FIG. 7.

The terms “source stream” or “source RTP stream” or “source flow” are used interchangeably herein to refer to data streams comprised of various source blocks of data. Examples of source streams may include audio and video data streams that may be used to provide streaming media services (e.g., streaming movies, radio, etc.) and/or telephony communications (e.g., Internet protocol (IP) audio/video chat) transmitted between computing devices over a networking connection (e.g., Internet, P2P, etc.). The terms “repair stream” or “FEC RTP stream” or “repair flow” or “FEC flow” are used interchangeably herein to refer to data streams comprised of redundant data corresponding to source streams. For example, FEC streams may include various repair blocks that may be used by receiver devices to repair, replace, or otherwise compensate for missing, lost, and/or corrupt data of source streams.

The embodiment techniques of this application address novel improvements to Forward Error Correction (FEC) with relation to Real-Time Protocol (RTP) data streams, and thus improve upon various conventional or standard FEC and/or RTP concepts. Accordingly, in the following descriptions, references may be made to various concepts (e.g., specifications, formats, standards) that are described in or related to the following documents: Internet Engineering Task Force (IETF) Request For Comments (RFC) document 4288, entitled “Media Type Specifications and Registration Procedures”, dated December 2005 (“RFC4288”); Internet Engineering Task Force (IETF) Request For Comments (RFC) document 4855, entitled “Media Type Registration of RTP Payload Formats”, dated February 2007 (“RFC4855”); Internet Engineering Task Force (IETF) Request For Comments (RFC) document 5053, entitled “Raptor Forward Error Correction Scheme for Object Delivery”, dated October 2007 (“RFC5053”); Internet Engineering Task Force (IETF) Request For Comments (RFC) document 5285, entitled “A General Mechanism for RTP Header Extensions”, dated July 2008 (“RFC5285”); Internet Engineering Task Force (IETF) Request For Comments (RFC) document 6330, entitled “RaptorQ Forward Error Correction Scheme for Object Delivery”, dated August 2011 (“RFC6330”); Internet Engineering Task Force (IETF) Request For Comments (RFC) document 6363, entitled “Forward Error Correction (FEC) Framework”, dated October 2011 (“RFC6363”); Internet Engineering Task Force (IETF) Request For Comments (RFC) document 6364, entitled “Session Description Protocol Elements for the Forward Error Correction (FEC) Framework”, dated October 2011 (“RFC6364”); Internet Engineering Task Force (IETF) Request For Comments (RFC) document 6681, entitled “Raptor Forward Error Correction (FEC) Schemes for FECFRAME”, dated August 2012 (“RFC6681”); and Internet Engineering Task Force (IETF) Request For Comments (RFC) document 6682, entitled “RTP Payload Format for Raptor Forward Error Correction (FEC)”, dated August 2012 (“RFC6682”).

In general, to protect against packet loss in RTP streams, a computing device implementing conventional FEC techniques can partition a source stream into source blocks of data, which can be done on-the-fly as the source stream becomes available. The computing device may generate an encoding block that includes data of the source block and FEC repair information based on the source block data to provide protection against packet loss. The encoding block may be transmitted in a repair stream corresponding to the source stream so that a receiver device can potentially recover the source block when there is some packet loss in the source stream. Typically, FEC streaming techniques utilizing smaller source blocks may result in better end-to-end latency as smaller source blocks reduce the amount of data to encode for encoding blocks. However, the error recovery potential with smaller source blocks is limited. With larger source blocks, FEC streaming techniques may have better recovery performance but require more bandwidth. In general, multiple RTP streams may not be favored, as too many RTP streams may be blocked by firewalls, require significant bandwidth, or otherwise be prohibited by broadband networks.

FEC FRAME provides specific code options that allow for support of sequenced data flows, such as RTP streams (i.e., source RTP streams). In such cases, a sending computing device may send a source RTP stream without modification, and may also send a separate repair FEC RTP stream associated with the source RTP stream that includes data (i.e., a “repair FEC payload ID”) that enables the FEC RTP stream to refer back to the source RTP stream. In particular the repair FEC payload ID may identify the sequence number of initial RTP packets of the source RTP stream that were used in creation of each repair packet of the FEC RTP stream. Such conventional implementations typically provide for redundancy in a 1-to-1 manner (i.e., one repair flow for one source flow).

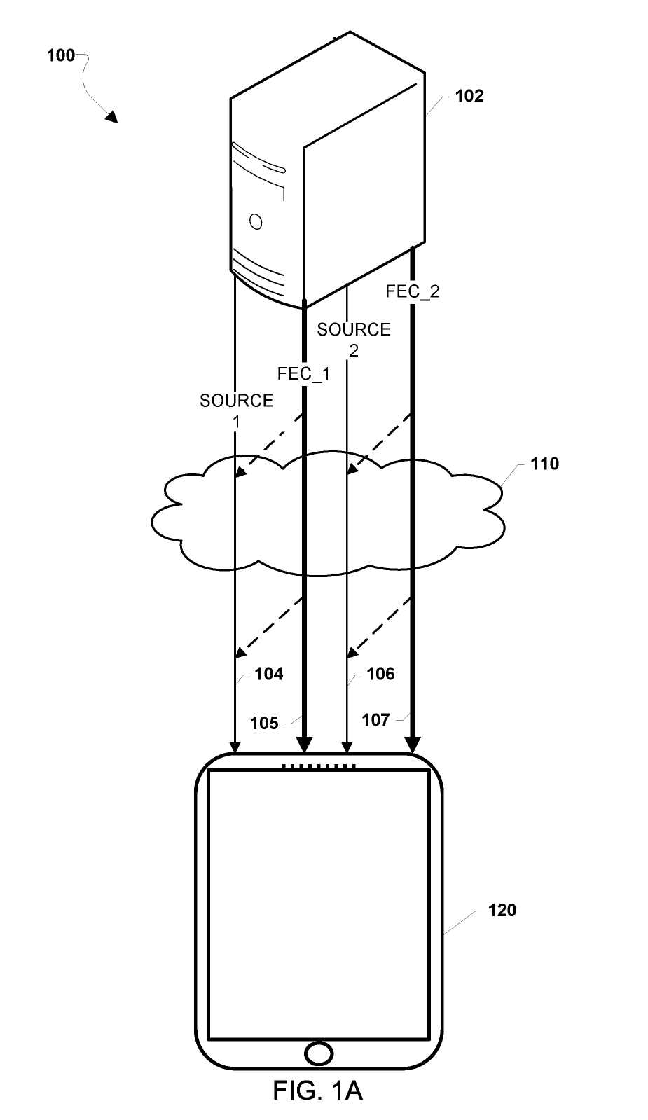

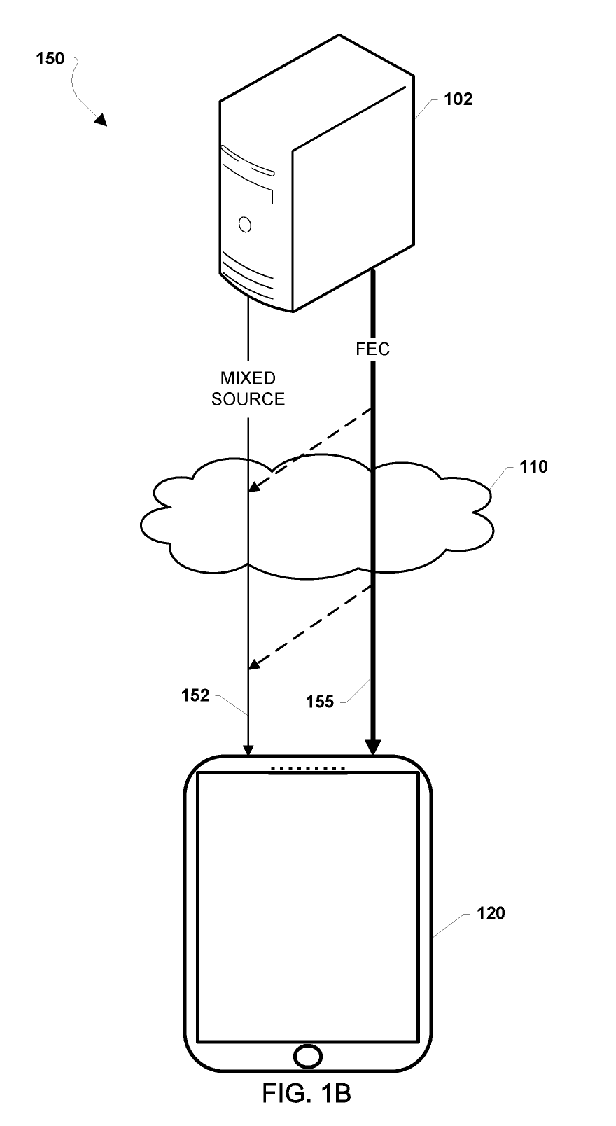

FIGS. 1A-1B illustrate conventional RTP stream exchanges between computing devices. With conventional RTP streams, sequence numbers may be assigned to each packet that is sent out for packet identification purposes. FEC RTP streams (or “repair streams”) may be generated that may identify such sequence numbers from individual source RTP streams. However, conventional FEC RTP streams are configured to provide redundancy for only a single source stream (e.g., protection only for a video stream protection or for an audio stream).

FIG. 1A illustrates such a conventional scenario 100, in which a sending computing device 102 (e.g., a media-streaming server, etc.) is shown transmitting a plurality of FEC RTP streams 105, 107 with associated source RTP streams 104, 106 to a receiving computing device 120 (e.g., a smartphone mobile device, a tablet, a laptop, etc.). The streams 104, 105, 106, 107 may be transmitted using wired or wireless connections to a network 110, such as a local area network, a cellular network, the Internet, etc. The sending computing device 102 may be configured to transmit a first FEC RTP stream 105 that includes repair blocks having redundant data for source blocks of a first source RTP stream 104 as well as a second FEC RTP stream 107 that includes repair blocks having redundant data for source blocks of a second source RTP stream 106. This configuration provides some mechanism for avoiding packet loss of the source RTP streams 104, 106. However, this configuration may require a larger number of total RTP streams. Such a requirement may be suboptimal for bandwidth and/or network operator/carrier specification or other limitations. The scenarios illustrated in FIG. 1A may be utilized in conventional use of browser applications to conduct peer-to-peer (P2P) video-audio calls (e.g., “Web Real-Time Communication” (WebRTC) technologies).

In some scenarios, source content is combined or mixed in order to reduce the number of streams transmitted and enable use of a single FEC RTP stream. In particular, RFC6681 describes conventional techniques that allow for protection of a single source RTP stream composed of multiple sources, in which each of the multiple sources may be identifiable by a Coordinating Source (CSRC) RTP header.

FIG. 1B illustrates such a conventional scenario 150 in which a sending computing device 102 (e.g., a server) is shown transmitting a single FEC RTP stream 155 with an associated mixed-source RTP stream 152. For example, the mixed-source RTP stream 152 may include a plurality of audio streams that have been mixed together by the sending computing device 102. For example, the sending computing device 102 may combine multiple audio tracks corresponding to multiple speakers of a conference call. The FEC RTP stream 155 may be configured to provide redundancy for recovery of missed/lost data of the mixed-source RTP stream 152. However, this technique may be of limited value, as the sending computing device 102 and receiving computing device 120 may be required to expend additional resources for mixing and processing the combined source data due to the FEC RTP stream merely addressing a single, albeit combined-source stream. Further, such a technique may be suboptimal as combined source streams are typically for same-type streams (e.g., all audio streams). Thus, these techniques may not provide singular FEC support for transmissions of different media types (e.g., audio stream and a video stream).

To address the limitations of conventional FEC techniques described above, various embodiments provide methods, devices, systems, and non-transitory process-readable storage media for “bundled FEC protection,” in which a single repair flow may be used to provide recovery protection for a plurality of individual source RTP streams. As such bundled FEC protection of a plurality of source RTP streams is not precisely defined for RTP by current standards (e.g., those defined in RFC6681), embodiments may employ protocol extensions to FEC FRAME for supporting FEC protection for multiple RTP source streams. In other words, the embodiment techniques may utilize novel FEC source payload and repair payload definitions that enable a single repair flow to be defined for multiple RTP flows. For example, as FEC FRAME Raptor code options do not currently address the case of bundled protection of multiple media types over multiple real-time transport protocol (RTP) synchronization sources (SSRC's), RTP stream header extensions may be utilized to allow a single FEC RTP stream to be configured to provide redundancy for a plurality of source RTP streams, regardless of their content type (e.g., audio or video). Based on such extensions, the embodiment techniques allow for protection of multiple source RTP streams that each has a unique sequence number space.

In some embodiments, bundled FEC protection may be accomplished using explicit source FEC payload ID's within RTP header extensions of source RTP streams (i.e., the “explicit source identification” technique). Such RTP header extensions may identify the source payload ID (written in the header extension) so that receiving computing devices of source RTP streams and their associated FEC RTP stream may match repair payloads to source payloads based on the source payload ID. This explicit source identification technique may require modification to source RTP streams.

In some embodiments, bundled FEC protection may be accomplished by configuring FEC RTP streams to include adequate references to source RTP streams so that RTP header extensions do not have to be used as in other embodiments (i.e., the “implicit source identification” technique). Such an implementation may not modify source RTP streams (or their header structures), but instead may define and utilize a different type of FEC repair ID that may identify all source RTP streams involved in making a repair payload of an FEC RTP stream. This implicit source identification technique may not require modification to source RTP streams.

The embodiment techniques may be beneficial by enabling a single FEC stream to simultaneously provide protection for different types of media (e.g., audio and video). The embodiment techniques may be further beneficial by utilizing larger payloads, making the recovery potential greater as FEC codes typically work better with larger payloads/streams. For example, if an FEC stream is provided to support a single audio source RTP stream, the repair payloads corresponding to the source payloads may be rather small, causing payloads to be broken up in small chunks, thus resulting in decreased FEC benefit. However, if an FEC stream addressed both audio and video streams, which typically have much larger source payload sizes, FEC operations may be more effective. Further, bundled FEC protection as enabled by the various embodiments may keep total RTP stream counts lower, and thus improve bandwidth use as there would be no need for 1-to-1 relationships between individual source streams and repair streams.

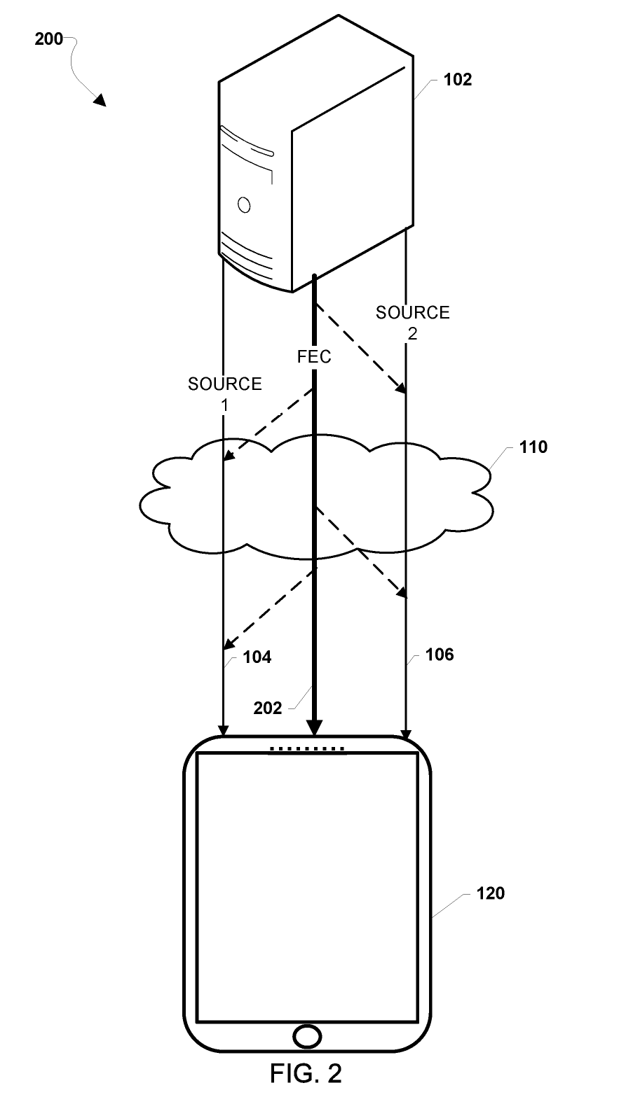

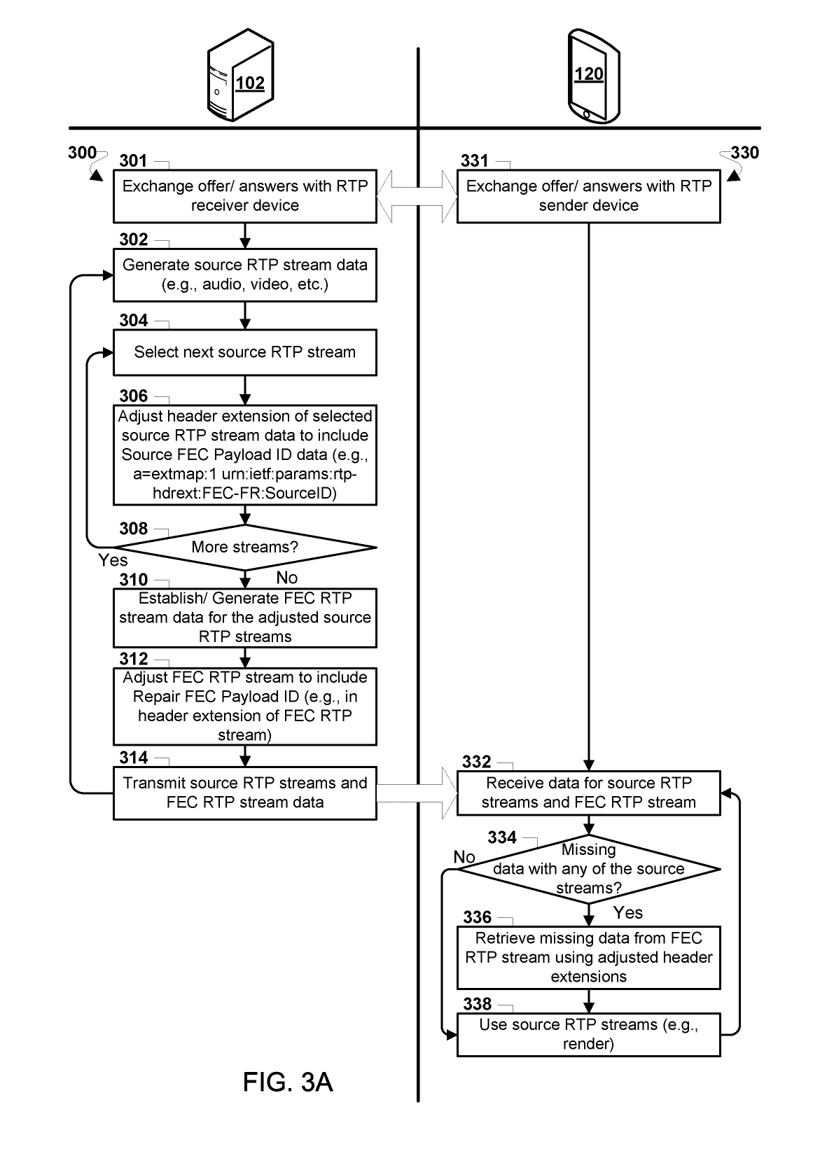

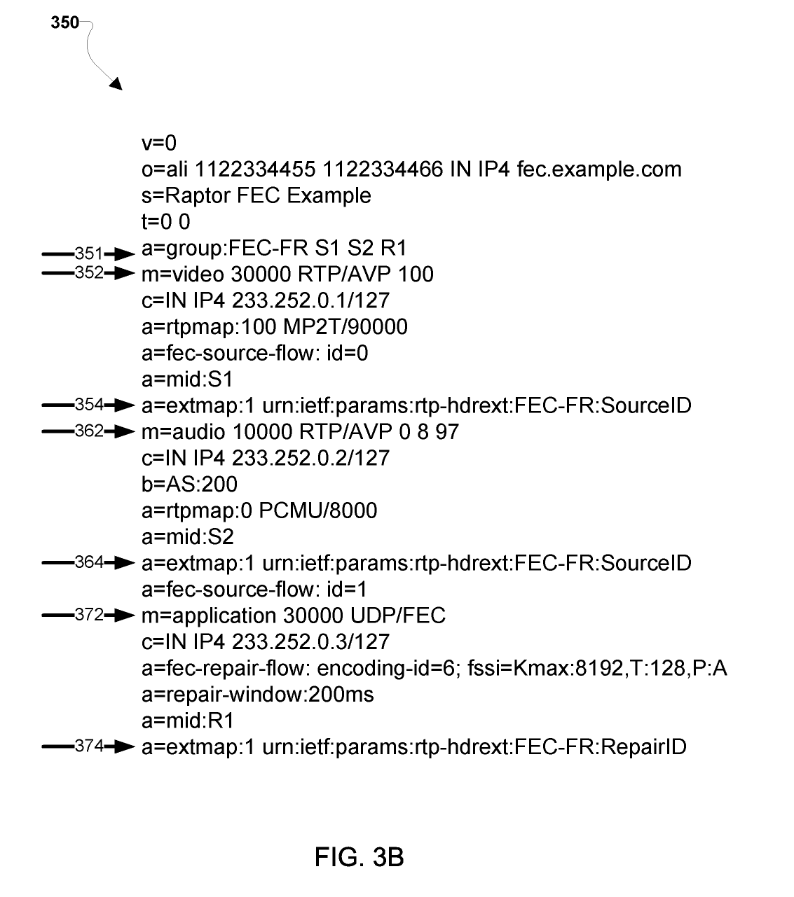

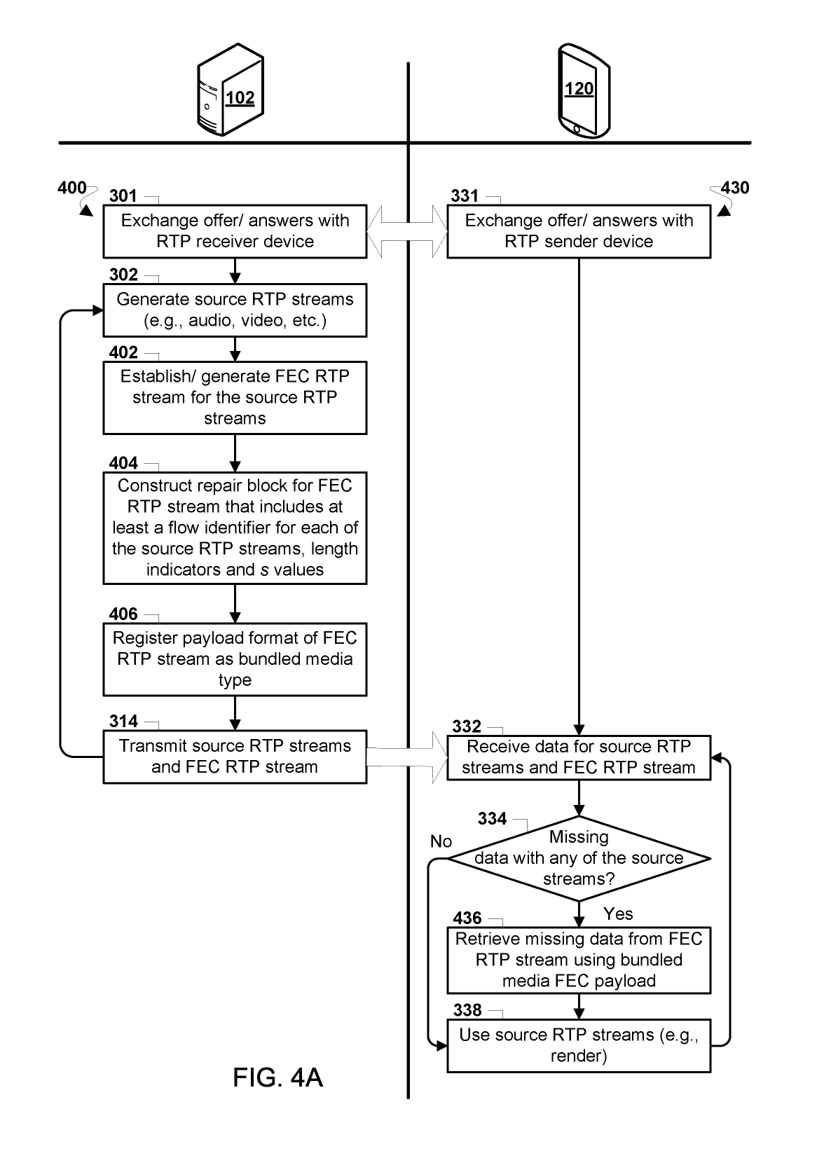

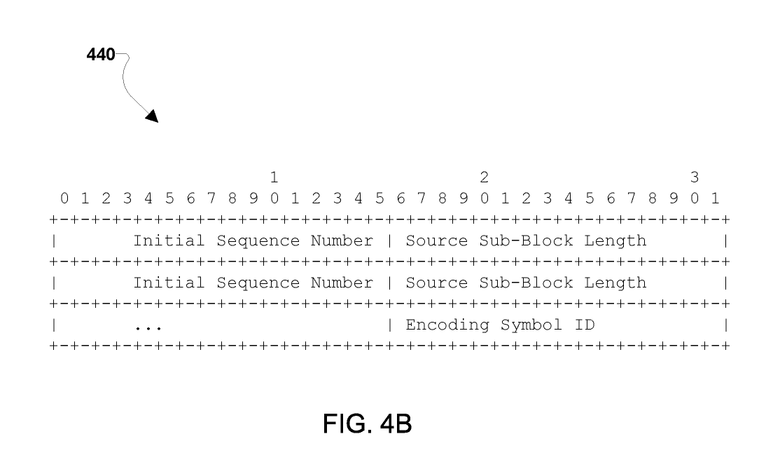

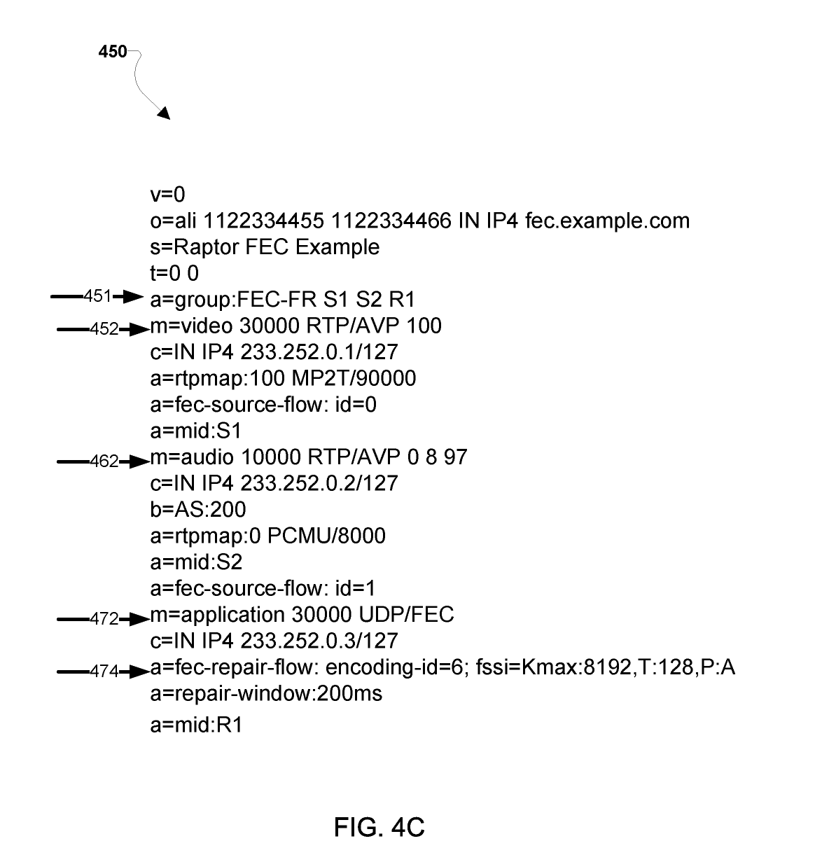

FIG. 2 illustrates a scenario 200 in which a bundled FEC RTP stream 202 is transmitted along with a plurality of source RTP streams 104, 106 according to various embodiments. In particular, the sending computing device 102 may be configured to transmit the FEC RTP stream 202 that includes repair blocks having redundant data for source blocks of both the first source RTP stream 104 and the second source RTP stream 106. This provides a mechanism for avoiding packet loss, such that the receiving computing device 120 may obtain missing/corrupt data from either source RTP stream 104, 106 from the FEC RTP stream 202. Such a scenario may be implemented using either the explicit source identification technique as further described below with reference to FIGS. 3A-B, or the implicit source identification technique as described below with reference to FIGS. 4A-4C.

Arbitrary multi-sequenced source streams may be protected if the source is identified explicitly using a source FEC payload ID (e.g., send source FEC payload ID along with the source payload as defined in Section 6 of RFC6681). However, source stream header information may be modified to include such source information that may be used in combination with data within a single FEC stream to recover missing packets. In particular, the source FEC payload ID may be sent in a header extension of a source RTP stream transmitted from a sending computing device to a receiving computing device. FIGS. 3A-3B address such embodiments in which source RTP streams may be modified to include header extensions for providing the source FEC payload ID.

FIG. 3A illustrates embodiment methods 300 and 330 for computing devices to exchange source RTP streams with header extensions along with a bundled FEC RTP stream (i.e., the “explicit source identification” technique.). The operations of the method 300 may be performed by a processor of a sending computing device 102 and the operations of the method 330 may be performed by a processor of a receiving computing device 120. In various scenarios, any computing device may be configured to either send or receive according to the methods 300, 330. In various embodiments, the methods 300, 330 may utilize an FEC RTP stream that includes repair payload IDs that utilize syntax/formatting as described within RFC6681, and source RTP streams that include source payload IDs that also utilize the syntax/formatting as described within RFC6681, as well as extended RTP header (or header extension) based on RFC5285.

The processor of the sending computing device 102 may exchange offer/answers with the receiver computing device 120 in block 301 of the method 300, and similarly the processor of the receiving computing device 120 may exchange offer/answers with the sending computing device 102 in block 331 of the method 330. The operations of blocks 301 and 331 may be considered session initialization (or session startup) operations in which both devices may use a protocol, such as Session Description Protocol (SDP), to exchange session initialization data and determine whether bundled FEC protection for a plurality of source RTP streams may be implemented via an FEC RTP stream.

Returning to method 300, the sending computing device 102 may generate source RTP streams (or stream data) in block 302, such as audio stream data, video stream data, etc. In block 304, the sending computing device 102 may select a next source RTP stream of a plurality of source RTP streams to send to the receiving computing device 120 (i.e., N-count streams). For example, for the first iteration of the operational loop of the method 300, the sending computing device 102 may select the first source RTP stream in a list of source RTP streams. In block 306, the sending computing device 102 may adjust a header extension of the selected source RTP stream (or source data within the selected source RTP stream) to include source FEC payload ID data. Data for an example header extension may be defined in SDP data received at the sending computing device, such as with the SDP line “a=extmap:1 urn:ietf:params:stp-hdrext:FEC-FR:SourceID”. The source FEC payload ID may be used in an RTP header extension for each source RTP source stream packet.

In some embodiments, the source FEC payload ID may be 32 bits long (i.e., 4 bytes), such that the 1-byte header extension solution (as defined in Section 4.2 of RFC5285) may be sufficient for identifying the source FEC payload ID. In some embodiments, a 2-byte header extension may be used as provided in Section 4.3 of RFC5285, for example when there is a need for an 8-bit extension ID encoding. In some embodiments, the source FEC payload ID may be defined in Section 6.2.2 of RFC6681.

In determination block 308, the sending computing device 102 may determine whether there are more source RTP streams to process. In response to determining there are more source RTP streams to process (i.e., determination block 308=“Yes”), the sending computing device 102 may continue to select another source RTP stream with the operations in block 304.

In response to determining there are no more source RTP streams to process (i.e., determination block 308=“No”), the sending computing device 102 may establish/generate the FEC RTP stream (or FEC RTP stream data) for the adjusted source RTP streams in block 310. In block 312, the sending computing device 102 may adjust the FEC RTP stream (or FEC RTP stream data) to include a repair FEC payload ID, such as by adding the repair FEC payload ID to a header extension of the FEC RTP stream. For example, the sending computing device 102 may adjust the FEC RTP stream to include a repair FEC payload ID as provided to the sending computing device 102 during the session initialization (e.g., via SDP data received via an out-of-band signal).

In some embodiments, the repair FEC payload ID may be defined in Section 6.2.3 of RFC6681, and may be sent along with the associated repair payload in the FEC RTP stream. In some embodiments, the repair FEC payload ID may also be sent as a RTP header extension, although it may be included in the RTP payload of the FEC RTP stream. As with the source FEC payload ID, a 1-byte header extension or a 2-byte header extension may be used in some embodiments for the repair FEC payload ID.

In block 314, the sending computing device 102 may transmit the source RTP streams and the FEC RTP stream data to the receiving computing device, such as via a wide area network (WAN). The sending computing device 102 may continue with the operations in block 302 for generating new source RTP stream data (e.g., source blocks).

Returning to method 330, the sending computing device 102 may receive the data of the source RTP streams and the FEC RTP stream from the sending computing device 102 in block 332. In determination block 334, the receiving computing device 120 may determine whether there is any missing data (e.g., missing source blocks) with any of the source RTP streams. In response to determining there is missing data (i.e., determination block 334=“Yes”), the receiving computing device 120 may retrieve the missing data (or missing source block data) from the FEC RTP stream (e.g., from FEC or repair blocks) using the adjusted header extensions in block 336. In response to determining there is no missing data (i.e., determination block 334=“No”) or in response to performing the operations of block 336, the receiving computing device 120 may use the source FEC streams in block 338, such as by rendering audio and/or video as part of an IP telephony call or other streaming media (e.g., streaming movies, etc.). The receiving computing device 120 may continue receiving subsequent RTP streams in block 332.

In some embodiments, the source FEC payload ID and/or the repair FEC payload ID may utilize new RTP Header Extension uniform resource identifiers (URIs) defined in the RTP Compact Header Extensions subregistry of the Real-Time Transport Protocol (RTP) Parameters registry. For example, the source FEC payload ID may utilize an extension URI such as “urn:ietf:params:rtp-hdrext:FEC-FR:SourceID” and the repair FEC payload ID may utilize an extension URI such as “urn:ietf:params:rtp-hdrext:FEC-FR:RepairID”.

FIG. 3B is an example of SDP data 350 that indicates the use of a bundled FEC RTP stream corresponding to source RTP streams (e.g., audio and video streams) with header extensions suitable for use in various embodiments. The SDP data may include various lines indicating characteristics of the RTP streams used in a communication between the receiving computing device 120 and sending computing device 102. The order of the lines (or inlines) of such SDP data may define the appearance of the source streams/packets in eventual transmissions. In some embodiments, such SDP data may be received by a sending or receiving computing device 120 during a session initialization phase via out-of-band signaling. In some embodiments, the SDP lines may be formatted based on the guidance provided in Section 5 of RFC5285, and further may include information related to FEC protection that may be derived from Section 10 of RFC6681.

The following is an illustration of SDP data. In general, an ‘a=group:’ line may be included within SDP data and may address all MID's of a group, wherein the MID's may be identifiers associated with m-lines of the SDP data that describe the streams to be sent, such as audio or video streams. Other lines of the SDP data may provide “extmap:” parameters for the associated m-lines, wherein the “extmap:” parameters may be specific to the type of RTP extension header being used for each associated stream. In particular, the SDP data may include a line 351 (e.g., an “a=group:” attribute line) that indicates an order of the RTP streams of a group (e.g., S1, S2, R1). Lines 352, 362, 372 may be considered m-lines identified by the first line 351. The SDP data may include a first line 352 indicating that a first source RTP stream (e.g., a video stream) is to be transmitted. A second line 354 may include “extmap:” parameters that indicate that the first source RTP stream may utilize header extensions for FEC purposes (e.g., may include a source payload ID). The SDP data may include a third line 362 indicating that a second source RTP stream (e.g., an audio stream) is to be transmitted. A third line 364 may include “extmap:” parameters that indicate that the second source RTP stream may utilize header extensions for FEC purposes (e.g., may include a source payload ID). The SDP data may include a fifth line 372 that may indicate that an FEC RTP stream is to be transmitted. A sixth line 374 may include “extmap:” parameters that indicate that the FEC RTP stream may utilize header extensions (e.g., may include the repair payload ID).

FIG. 4A illustrates embodiment methods 400 and 430 for computing devices to exchange unmodified source RTP streams with a bundled FEC RTP stream (i.e., the “implicit source identification” technique.). In other words, FIG. 4A illustrates techniques for using multi-sequenced flows without source FEC payload IDs. The methods 400, 430 may be similar to the methods described above with reference to FIG. 3A, except that the methods 400, 430 do not include operations to modify source RTP streams. Instead, in the methods 400, 430, the sending computing device 102 and the receiving computing device 120 may only make adjustments to the information transmitted within the FEC RTP stream in order to support recovery for lost data within the source streams. In particular, the repair FEC payload ID of the FEC RTP stream may be used without editing the source RTP streams. In this manner, the repair payload ID may increase in size with the number of source RTP streams that are protected via the FEC RTP stream. This technique may be more costly regarding the generation of the FEC RTP stream, as the sending computing device 102 may be required to identify each sequence number, number of bytes taken from each source RTP stream, as well as information indicating the source RTP stream in the repair payload ID for use in the FEC RTP stream.

The operations of the method 400 may be performed by a processor of a sending computing device 102 and the operations of the method 430 may be performed by a processor of a receiving computing device 120. In various scenarios, any computing device may be configured to either send or receive accord to the methods 400, 430. Although Section 8 of RFC6681 describes procedures for single-sequenced flows, the various embodiments extend this single-sequenced flow method for multi-sequenced flows, in particular multiple RTP flows corresponding to different synchronization sources (i.e., SSRC's). In various embodiments, implicit source identification techniques may be used for various FEC codes, such as FEC Scheme ID 5 and 6. In various embodiments, the methods 400, 430 may utilize a FEC RTP stream that includes repair payload IDs that utilize syntax/formatting as described within RFC6681, and source RTP streams that include source payload IDs that also utilize the syntax/formatting as described within RFC6681.

The operations of blocks 301, 302, 314 of the method 400 and the operations of blocks 331, 332, 334, 338 of the method 430 may be similar to the operations of like numbered blocks described above with reference to FIG. 3A. In block 402, the processor of the sending computing device 102 may establish/generate an FEC RTP stream (or FEC RTP stream data) for the plurality of source RTP streams. The operations of block 402 may be similar to the operations of block 310 of FIG. 3A, except that the operations of block 402 may establish/generate the FEC RTP stream based on source RTP streams that have not been modified to include header extensions.

In block 404, the sending computing device 102 may construct a repair block for the FEC RTP stream that includes at least a flow identifier for each of the source RTP streams, length indicators and s values (i.e., a smallest integer values as defined within RFC6681, Section 5). In some embodiments, only one format for the repair FEC payloads may be provided with necessary extensions for multi-sequenced flows. In some embodiments, the number of flows in a repair packet and the order in which the flows appear in the repair packet may be determined using out-of-band signaling (e.g., via SDP data as illustrated below in FIG. 4C).

In some embodiments, source symbol construction may be performed by the sending computing device 102 during the operations of block 404. In particular, the sending computing device 102 may utilize the FEC Scheme 5 and FEC Scheme 6 procedures as defined in Section 5 of RFC6681 to construct a set of source symbols to which the FEC code can be applied. For example, during the construction of the source block, the sending computing device 102 may determine a flow identifier (i.e., f[i]) for each source RTP stream (or flow) included in the source packet information, a length indication (i.e., l[i]) included in the source packet information for each packet and dependent on the protocol carried within the transport payload, and a value of s (i.e., s[i]) in the construction of the source packet information for each packet that may be identified as the smallest integer such that s[i]*T>=(l[i]+3), in which T may be a source symbol size in octets, and i may be the source RTP stream index.

In some embodiments, derivations of source FEC packet identification information may be utilized by the sending computing device. For example, the source FEC Packet identification information for a source packet may be derived from the flows in each packet, sequence number of each individual flow of the packet, and information received in any repair FEC packet belonging to this source block. The application data units (ADU's) that constitute the source block may be identified by the associated flow identifier and sequence number of the first source packet in the block. This information may be signaled in all repair FEC packets associated with the source block in the Initial Sequence Number field.

In some embodiments, the length of the source packet information (in octets) for source packets within a source block may be equal to the length of the payload containing encoding symbols of the repair packets (i.e., not including the repair FEC payload ID) for that block, which may be the same for all repair packets. The Application Data Unit Information Length (ADUIL) in symbols may be equal to this length divided by the encoding symbol size (which may be signaled in the FEC framework configuration information). The set of source packets included in the source block may be determined by the Initial Sequence Number (ISN) and Source Sub-Block Length (SSBL) as follows: Let f be the index of the flow (i.e., if f refers to the first flow in the source block then f=1), I(f) be the Initial Sequence Number of the source sub-block from flow f, LP(f) be the Source Sub-Block Information Length in symbols for flow f, LB(f) be the Source Sub-Block Length in symbols for flow f. Then, source packets with sequence numbers from I(f) to I(f)+(LB(f)/LP(f))−1 for flow f inclusive may be included in the source block. The Source Sub-Block Length (SSBL), LB(f), may be chosen such that it is at least as large as the largest Source Packet Information Length LP(f).

In some embodiments, for FEC Scheme 1, the encoding symbol ID (ESI) value placed into a repair packet may be calculated as specified in Section 5.3.2 of RFC5053. In some embodiments, for FEC Scheme 2, the ESI value placed into a repair packet may be calculated as specified in Section 4.4.2 of RFC6330. However, in either FEC Scheme 1 or Scheme 2, K (i.e., a number of source symbols of a certain size T octets that source blocks may be divided into, such as defined in RFC6330, Section 4.4.1) may be identical to the sum of all the SSBL's indicated in the repair packet.

In some embodiments, for RTP source packet flows, the RTP Sequence Number field may be used as the sequence number in the procedures described above. The length indication included in the Application Data Unit Information may be the sum over all flows of the RTP payload length plus the length of the contributing sources (CSRCs), if any, the RTP Header Extension, if present, and the RTP padding octets, if any. This length may be typically equal to the user datagram protocol (UDP) payload length of the packet minus 12.

In block 406, the sending computing device 102 may register a payload format of the FEC RTP stream as a bundled media type, and may transmit the source RTP streams and FEC RTP stream data to the receiving computing device 120 in block 314. In some embodiments, the RTP payload format may be registered using the ‘bundled/raptorfec’ media type that may be registered in accordance with RFC4855 and that uses the template of RFC4288. Such a media type definition may be identical to ‘video/raptorfec’ that can be found in Section 6.2.1 of RFC6682.

In block 332 of method 430, the receiving computing device 120 may receive the source RTP streams and FEC RTP stream data. Unlike the source RTP streams discussed in FIG. 3A, the source RTP streams in FIG. 4A may not include a source FEC payload ID (i.e., the source packets of the source RTP streams may not be modified). Due to out-of-band signaling, such as received during the session initialization (e.g., during the operations of block 331), the receiving computing device 120 may already know the first sequence number or source block length corresponding to the various source RTP streams. The receiving computing device 120 may expect that there will be packets (or blocks) contributed from each source RTP stream within the FEC RTP stream (i.e., each repair packet of the FEC RTP stream may be expected to include an equal number of source bytes from each stream). If no FEC repair packets are received, then no FEC decoding may be possible, and it may be unnecessary for the receiving computing device 120 to identify the source FEC packet identification information for the source RTP stream packets.

In determination block 334 the receiving computing device 120 may determine whether there is missing data in one of the source RTP streams as described above with reference to FIG. 3A for the like numbered block. In response to determining there is missing data in one of the source RTP streams (i.e., determination block 334=“Yes”), the receiving computing device 120 may retrieve the missing data (or missing source block data) from the FEC RTP stream using the bundled media FEC payload in block 436. In response to determining there is no missing data from the source RTP streams (i.e., determination block 334=“No”) or in response to performing the operations of block 436, the receiving computing device 120 may use the source RTP streams in block 338 and continue receiving packets in block 332.

FIG. 4B is an example of a FEC payload format 440 suitable for use in various embodiments. The FEC payload format 440 illustrated in FIG. 4B may be similar to the Format ‘A’ defined in Section 8.1.3 of RFC6681, except that the FEC payload format 440 includes necessary extensions for multi-sequenced flows. Regarding the multi-sequence repair FEC payload ID format 440, the “Initial Sequence Number” (ISN) field (e.g., Flow i ISN) may be 16 bits and may be a field that specifies the lowest 16 bits of the sequence number of the first packet to be included in this sub-block. If the sequence numbers are shorter than 16 bits, the received Sequence Number may be logically padded with zero bits to become 16 bits in length, respectively. The ISN field type may be an unsigned integer. The Source Sub-Block Length (SSBL) field may be 16 bits and may specify the length of the source sub-block in symbols. The SSBL field type may be an unsigned integer. The Encoding Symbol ID (ESI) field may be 16 bits and may indicate which repair symbols are contained within this repair packet. The ESI provided may be the ESI of the first repair symbol in the packet. The ESI field type may be an unsigned integer.

FIG. 4C illustrates an example of SDP data 450 indicating a bundled FEC RTP stream corresponding to source RTP streams suitable for use in some embodiments. Such SDP data 450 may provide to sending/receiving computing devices the number of flows in a repair packet and the order in which the flows appear in the repair packet, and may be delivered to these devices using out-of-band signaling. The SDP data 450 may be similar to the SDP illustrated in FIG. 3B described above, except the SDP data 450 does not indicate header extensions for the source RTP streams. As described above, the order of the lines (or inlines) of the SDP data 450 may define the appearance of the source streams/packets in eventual transmissions. In some embodiments, the SDP data indicating bundled FEC protection may be derived from Section 10 of RFC6681.

As an illustration, the SDP data may include a line 451 (e.g., an “a=group:” attribute line) indicating the order of appearance of the RTP streams (i.e., S1, S2, R1). The SDP data 450 may include a first line 452 (e.g., an m-line) indicating that a first source RTP stream (e.g., a video stream) is to be transmitted. A second line 462 (e.g., an m-line) may indicate that a second source RTP stream (e.g., an audio stream) is to be transmitted. A third line 472 (e.g., an m-line) may indicate that an FEC RTP stream is to be transmitted. A fourth line 474 may indicate bundled configuration information for the FEC RTP stream.

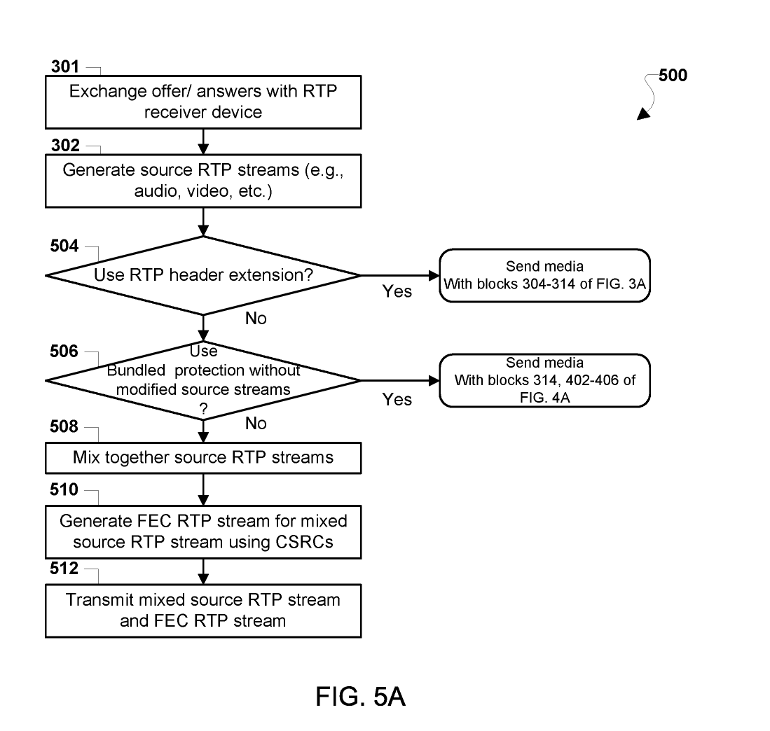

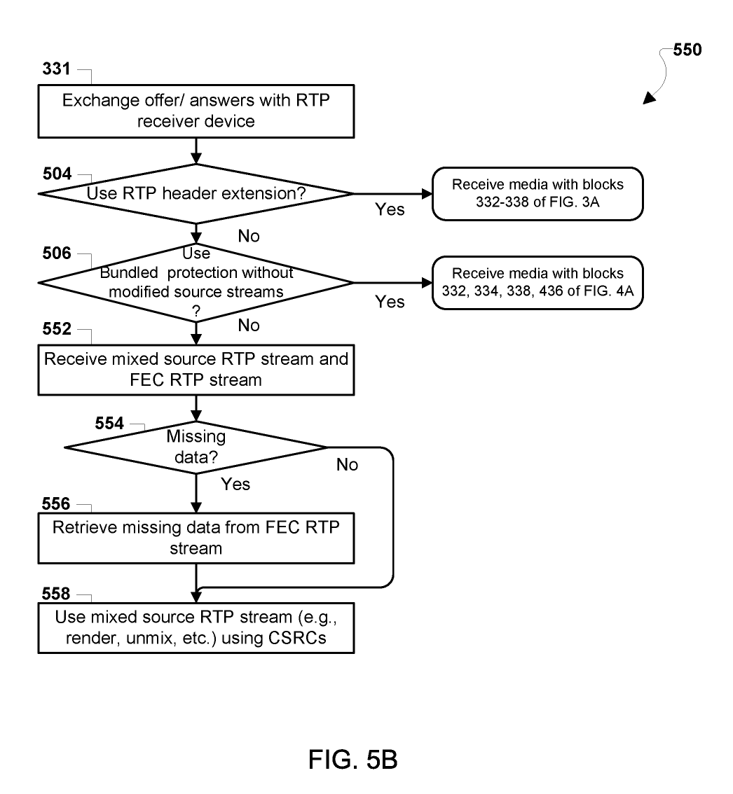

In some embodiments, sending and receiving computing devices may be configured to utilize explicit source identification techniques, implicit source identification techniques, and/or other techniques for providing FEC protection of source RTP streams. FIGS. 5A-5B illustrate embodiment methods for sending and receiving computing devices to dynamically utilize the various techniques.

FIG. 5A illustrates an embodiment method 500 for a sending computing device to transmit source RTP streams with a bundled FEC RTP stream in various configurations. In other words, the sending computing device may continually evaluate data associated with outgoing source RTP streams to determine how to enable bundled FEC protection. The operations of blocks 301-302 of the method 500 may be similar to the operations of like numbered blocks described above with reference to FIG. 3A.

In determination block 504, the sending computing device may determine whether to use the explicit source identification bundled FEC protection (i.e., an RTP header extension technique that uses modified source RTP streams). Such a determination may be based on SDP data received during the operations of block 301 and as illustrated in FIG. 3B. In response to determining that the RTP header extension should be used (i.e., determination block 504=“Yes”), the sending computing device may perform the sending operations of blocks 304-314 as described above with reference to FIG. 3A.

In response to determining that the RTP header extension should not be used (i.e., determination block 504=“No”), the sending computing device may determine whether to use the implicit source identification technique (i.e., no modification to source streams/no source RTP header extension) for providing bundled FEC protection in determination block 506. In response to determining that the implicit source identification technique should be used (i.e., determination block 506=“Yes”), the sending computing device may perform the sending operations of blocks 314, 402-406 as described above with reference to FIG. 4A.

In response to determining that the implicit source identification technique should not be used (i.e., determination block 506=“No”), bundled FEC protection over multiple RTP source flows may not be possible, and the sending computing device may be required to utilize a technique similar to as described in RFC6681 but that uses CSRC's to distinguish different source streams. For example, the sending computing device may use CSRCs to separate sources as may be normally used in mixing gateways (e.g., multiparty voice/video-conferencing bridges). In other words, the sending computing device may operate as a mixer for multiple sources. In block 508, the sending computing device may mix together source RTP streams, generate the FEC RTP stream for the mixed source RTP stream using CSRCs in block 510, and transmit the mixed source RTP stream and FEC RTP stream to the receiving computing device in block 512.

FIG. 5B illustrates an embodiment method 550 for a receiving computing device to receive and process source RTP streams with bundled FEC RTP streams in various configurations. The operations of block 331 of the method 550 may be similar to the operations of the like numbered block described above with reference to FIG. 3A.

In determination block 504, the receiving computing device may determine whether to use the explicit source identification bundled FEC protection (i.e., an RTP header extension technique that modified source streams). Such a determination may be based on SDP data received during the operations of block 331 and as illustrated in FIG. 3B. In response to determining that the RTP header extension should be used (i.e., determination block 504=“Yes”), the receiving computing device may perform the receiving and processing operations of blocks 332-338 as described above with reference to FIG. 3A.

In response to determining that the RTP header extension should not be used (i.e., determination block 504=“No”), the receiving computing device may determine whether to use the implicit source identification technique for providing bundled FEC protection in determination block 506 (i.e., no modification to source streams, no source RTP header extension). In response to determining that the implicit source identification technique should be used (i.e., determination block 506=“Yes”), the receiving computing device may perform the receiving and processing operations of blocks 332, 334, 338, 436 as described above with reference to FIG. 4A.

In response to determining that the implicit source identification technique should not be used (i.e., determination block 506=“No”), the receiving computing device may resort to utilizing a mixed-source RTP stream. The operations of blocks 552-558 may be similar to the operations of blocks 332-338 or blocks 332, 334, 436, 338 of FIG. 4A, except that the operations of blocks 552-558 may regard a single mixed-source RTP stream and the FEC RTP stream. For example, in order to use the source RTP stream with the operations in block 558, the receiving computing device may be required to perform separation operations for distinguishing the various mixed together streams prior to rendering, etc. Such separation operations may utilize the CSRCs. As an illustration, an endpoint in a multiparty call (e.g., a sending computing device) may send multiple audio streams at different encoder rates to support other parties in the call with different audio codec capabilities. These streams may be sent over a single RTP session (i.e., “audio multicasting”), where each audio stream may be identified by a CSRC. This receiving computing device may receive the single RTP session and identify the individual audio streams based on the included CSRC data.

Further details of the various embodiments described above may be found in the document entitled “FEC FRAME Raptor Extensions for Multiple RTP Synchronization Sources,” which is attached to this application and incorporated in this specification in its entirely as if presented here.

Various forms of computing devices, including personal computers and laptop computers, may be used to implement the various embodiments. Such computing devices typically include the components of the mobile device 120 illustrated in FIG. 6. In various embodiments, the mobile device 120 may include a processor 601 coupled to a touch screen controller 604 and an internal memory 602. The processor 601 may be one or more multicore ICs designated for general or specific processing tasks. The internal memory 602 may be volatile or non-volatile memory, and may also be secure and/or encrypted memory, or unsecure and/or unencrypted memory, or any combination thereof. The touch screen controller 604 and the processor 601 may also be coupled to a touch screen panel 612, such as a resistive-sensing touch screen, capacitive-sensing touch screen, infrared sensing touch screen, etc. The mobile device 120 may have one or more radio signal transceivers 608 (e.g., Bluetooth®, ZigBee®, Wi-Fi®, RF radio) and antennae 610, for sending and receiving, coupled to each other and/or to the processor 601. The transceivers 608 and antennae 610 may be used with the above-mentioned circuitry to implement the various wireless transmission protocol stacks and interfaces. The mobile device 120 may include a cellular network wireless modem chip 616 that enables communication via a cellular network and may be coupled to the processor. The mobile device 120 may include a peripheral device connection interface 618 coupled to the processor 601. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The mobile device 120 may also include speakers 614 for providing audio outputs. The mobile device 120 may also include a housing 620, constructed of a plastic, metal, or a combination of materials, for containing all or some of the components discussed herein. The mobile device 120 may include a power source 622 coupled to the processor 601, such as a disposable or rechargeable battery. The rechargeable battery may also be coupled to the peripheral device connection port to receive a charging current from a source external to the mobile device 120.

Various forms of computing devices, including personal computers, mobile computing devices (e.g., smartphones, etc.), servers, laptop computers, etc., may be used to implement the various embodiments. Such computing devices may typically include, at least, the components illustrated in FIG. 7, which illustrates an example server computing device. Such a server computing device 102 may typically include a processor 701 coupled to volatile memory 702 and a large capacity nonvolatile memory, such as a disk drive 703. The server computing device 102 may also include a floppy disc drive, compact disc (CD) or digital versatile disc (DVD) disc drive 706 coupled to the processor 701. The server computing device 102 may also include network access ports 704 (or interfaces) coupled to the processor 701 for establishing data connections with a network 705, such as the Internet and/or a local area network coupled to other system computers and servers.

The various processors described herein may be any programmable microprocessor, microcomputer or multiple processor chip or chips that can be configured by software instructions (applications) to perform a variety of functions, including the functions of the various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The steps of a method or algorithm disclosed herein may be embodied in a processor-executable software module or processor-executable software instructions, which may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for extending Forward Error Correction (FEC) to protect a plurality of Real-Time Protocol (RTP) streams using a single FEC RTP stream, comprising:
exchanging, via a processor of a sending computing device, session initialization data with a receiving computing device;
generating, via the processor, source RTP stream data for the plurality of source RTP streams;
generating, via the processor, FEC RTP stream data for an FEC RTP stream corresponding to the plurality of source RTP streams; and
transmitting the plurality of source RTP streams and the FEC RTP stream to the receiving computing device.

2. The method of claim 1, further comprising:
adjusting, via the processor, a header extension of each of the plurality of source RTP streams to include a source FEC payload identifier (ID).

3. The method of claim 2, further comprising:
adjusting, via the processor, the FEC RTP stream to include a repair FEC payload identifier (ID).

4. The method for claim 1, further comprising:
constructing, via the processor, a repair block of the FEC RTP stream for the plurality of source RTP streams, wherein the repair block includes at least a flow identifier, a length indicator, and s values for each of the source RTP streams; and
registering, via the processor, a payload format of the FEC RTP stream as a bundled media type.

5. The method of claim 1, wherein each of the plurality of source RTP streams is one of an audio stream and a video stream.

6. The method of claim 1, wherein the session initialization data comprises Session Description Protocol (SDP) data.

7. A method for extending Forward Error Correction (FEC) to protect a plurality of Real-Time Protocol (RTP) streams using a single FEC RTP stream, comprising:
receiving, via a processor of a receiving computing device, a plurality of source RTP streams and a FEC RTP stream from a sending computing device;
determining, via the processor, whether any source block data is missing from any of the plurality of source RTP streams;
retrieving, via the processor, missing source block data from repair blocks of the FEC RTP stream in response to determining that there is missing source block data; and
using, via the processor, the data of the plurality of source RTP streams.

8. The method of claim 7, wherein each of the plurality of source RTP streams is one of an audio stream and a video stream.

9. A computing device, comprising:
a transceiver;
a processor connected to transceiver and configured with processor executable instructions to perform operations comprising:
exchanging session initialization data with a receiving computing device;
generating source Real-Time Protocol (RTP) stream data for a plurality of source RTP streams;
generating Forward Error Correction (FEC) RTP stream data for an FEC RTP stream corresponding to the plurality of source RTP streams; and
transmitting the plurality of source RTP streams and the FEC RTP stream to the receiving computing device.

10. The computing device of claim 9, wherein the processor is configured with processor executable instructions to perform operations further comprising:
adjusting a header extension of each of the plurality of source RTP streams to include a source FEC payload identifier (ID).

11. The computing device of claim 10, wherein the processor is configured with processor executable instructions to perform operations further comprising:
adjusting the FEC RTP stream to include a repair FEC payload identifier (ID).

12. The computing device of claim 9, wherein the processor is configured with processor executable instructions to perform operations further comprising:
constructing a repair block of the FEC RTP stream for the plurality of source RTP streams, wherein the repair block includes at least a flow identifier, a length indicator, and s values for each of the source RTP streams; and
registering, via the processor, a payload format of the FEC RTP stream as a bundled media type.

13. The computing device of claim 9, wherein each of the plurality of source RTP streams is one of an audio stream and a video stream.

14. The computing device of claim 9, wherein the session initialization data comprises Session Description Protocol (SDP) data.

15. A computing device, comprising:
a transceiver;
a processor connected to transceiver, wherein the processor is configured with processor executable instructions to perform operations comprising:
receiving a plurality of source Real-Time Protocol (RTP) streams and a Forward Error Correction (FEC) RTP stream from a sending computing device;
determining whether any source block data is missing from any of the plurality of source RTP streams;
retrieving missing source block data from repair blocks of the FEC RTP stream in response to determining that there is missing source block data; and
using the data of the plurality of source RTP streams.

16. The computing device of claim 15, wherein each of the plurality of source RTP streams is one of an audio stream and a video stream.
